(19) United States
(12) Patent Application Publication
(10) Pub. No.: US 2006/0114994 A1
(43) Pub. Date: Jun. 1, 2006

(54) Noise reduction in a digital video

(76) Inventor: D. Amnon Silverstein, Mountain View, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/001,101

(22) Filed: Dec. 1, 2004

(51) Int. Cl. H04N 7/12; H04N 11/02; H04N 5/14; H04N 11/04; H04N 9/64; H04B 1/66

(52) U.S. Cl. 375/240.12; 348/700; 375/240.16

(57) ABSTRACT

A method performed by a processing system is provided. The method comprises determining a correspondence between a first pixel value in a first frame of a digital video and a second pixel value in a second frame of the digital video, processing the first pixel value and the second pixel value to remove noise and generate a third pixel value, and re-mapping the first pixel value in the first frame with the third pixel value.

### CROSS-REFERENCE TO RELATED APPLICATION

This application is related to U.S. patent application Ser. No. 10/824,692, filed on Apr. 15, 2004, entitled ENHANCING IMAGE RESOLUTION, and listing Mei Chen as an inventor. The above U.S. patent application is assigned to the assignee of the present invention and is hereby incorporated by reference herein.

### BACKGROUND

Movies, videos, and other images may be captured from one or more scenes using a video medium such as film and a video capture device such as a camera. After processing, the video medium may be used to reproduce the images by displaying the images using a display device such as a projector. The video medium may also be converted into other formats, e.g. from film into a digital format, for display or additional processing.

During the capturing, processing, or converting of a video medium, noise such as film grain may become a part of the video medium. The noise may cause undesirable effects to appear when the video medium is displayed. For example, a TechniColor camera captures images using a separate filmstrip for the red, green, and blue colors to generate red, green, and blue frames for each image. As a result, a TechniColor film captured with a TechniColor camera may have noise in one or more of the color frames of the film caused by film grain, dust, scratches, and other artifacts. In addition, additional noise may be generated in a digitized version of the TechniColor film in the process of converting the TechniColor film to a digital format. As another example, a photosensor array found in a digital camera may generate noise from thermal, electrical, or processing sources, e.g., compression.

It would be desirable to be able to reduce the amount of noise in a digital video.

### SUMMARY

One form of the present invention provides a method performed by a processing system. The method comprises determining a correspondence between a first pixel value in a first frame of a digital video and a second pixel value in a second frame of the digital video, processing the first pixel value and the second pixel value to remove noise and generate a third pixel value, and re-mapping the first pixel value in the first frame with the third pixel value.

### BRIEF DESCRIPTION OF THE DRAWINGS

FIG. 1 is a block diagram illustrating a processing system configured to reduce noise a digital video according to one embodiment of the present invention.

FIG. 2 is a flow chart illustrating a method for reducing noise a digital video according to one embodiment of the present invention.

FIG. 3 is a block diagram illustrating a process for reducing noise a digital video according to one embodiment of the present invention.

FIG. 4 is a flow chart illustrating a method for reducing noise a digital video using temporal windows according to one embodiment of the present invention.

FIGS. 5A and 5B are a flow chart illustrating a method for calculating and re-mapping pixel values according to one embodiment of the present invention.

FIG. 6 is a block diagram illustrating information used to calculate and re-map pixel values according to one embodiment of the present invention.

FIG. 7 is a flow chart illustrating a method for reducing noise a digital video using confidence measures according to one embodiment of the present invention.

FIG. 8 is a flow chart illustrating a method for reducing noise a digital video previously computed motion vectors according to one embodiment of the present invention.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following Detailed Description, therefore, is not to be taken in a limiting sense, and the scope of the present invention is defined by the appended claims.

As described herein, a system, method, and program product for generating an enhanced digital video is provided. The system, method, and program product contemplate re-mapping pixel values in a target frame in a digital video based on corresponding pixel values in nearby frames in the digital video. By re-mapping the pixel values in a target frame, noise such as film grain may be reduced in the target frame.

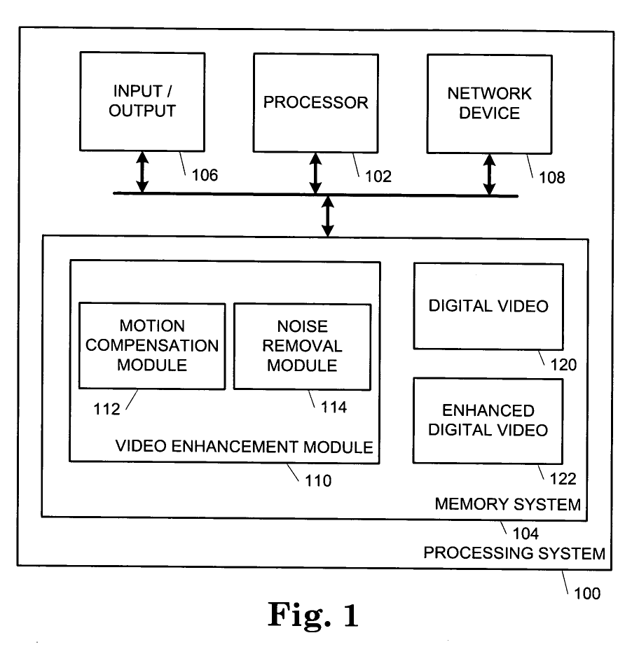

FIG. 1 is a block diagram illustrating a processing system 100 configured to remove artifacts from a digital video 120. Processing system 100 comprises a processor 102, a memory system 104, an input/output unit 106, and a network device 108. Memory system 104 is for storing a video enhancement module 110, a motion compensation module 112, a noise removal module 114, digital video 120, and an enhanced digital video 122.

Processing system 100 is configured to generate enhanced digital video 122 from digital video 120 using video enhancement module 110, motion compensation module 112 and noise removal module 114. Processing system 100 comprises any type of computer system or portable or non-portable electronic device. Examples computer systems include desktop, laptop, notebook, workstation, or server computer systems, and examples of electronic devices include digital cameras, digital video cameras, printers, scanners, mobile telephones, and personal digital assistants.

In one embodiment, video enhancement module 110, motion compensation module 112, and noise removal module 114 each comprise instructions stored in memory system 104 that are accessible and executable by processor 102. Memory system 104 comprises any number and types of volatile and non-volatile storage devices such as RAM, hard disk drives, CD-ROM drives, and DVD drives. In other embodiments, video enhancement module 110, motion compensation module 112, and noise removal module 114 may comprise any combination of hardware and software components configured to perform the functions described herein.

A user of processing system 100 manages and controls the operation of video enhancement module 110, motion compensation module 112, and noise removal module 114 by providing inputs and receiving outputs using input/output unit 106. Input/output unit 106 may comprise any combination of a keyboard, a mouse, a display device, or other input/output device that is coupled, directly or indirectly, to processing system 100.

Video enhancement module 110, motion compensation module 112, noise removal module 114, and digital video 120 may each be stored on a medium separate from processing system 100 (not shown) prior to being stored in processing system 100. Examples of such a medium include a hard disk drive, a compact disc (e.g., a CD-ROM, CD-R, or CD-RW), and a digital video disc (e.g., a DVD, DVD-R, or DVD-RW). Processing system 100 may access video enhancement module 110, motion compensation module 112, noise removal module 114, and digital video 120 from a remote processing or storage system (not shown) that comprises the medium using network device 108. Network device 108 may be coupled, directly or indirectly, to any type of wired or wireless local area, wide area, or global communications network.

Digital video 120 comprises a plurality of digital frames. Each frame may be displayed separately to form an image or in succession, e.g., 24 or 30 frames per second, to form a video (i.e., a set of images that may appear to be moving). Digital video 120 may comprise one or more scenes where a scene comprises a set of related frames. In one embodiment, digital video 120 comprises an RGB color space where each frame has a red frame with red pixel values, a blue frame with blue pixel values, and a green frame with green pixel values. The red, green, and blue pixel values are combined during the display of digital video 120 to reproduce the images of digital video 120. In other embodiments, each frame may comprise other sets of color frames or may combine the pixel values for each color.

Digital video 120 may be generated either from a video or other set of images from another medium, e.g., film, or from a camera or other image capture device directly. For example, a TechniColor film captured using a TechniColor camera may be converted into digital video 120 using a scanning process. In other embodiments, digital video 120 may comprise a single image frame or an unrelated set of image frames.

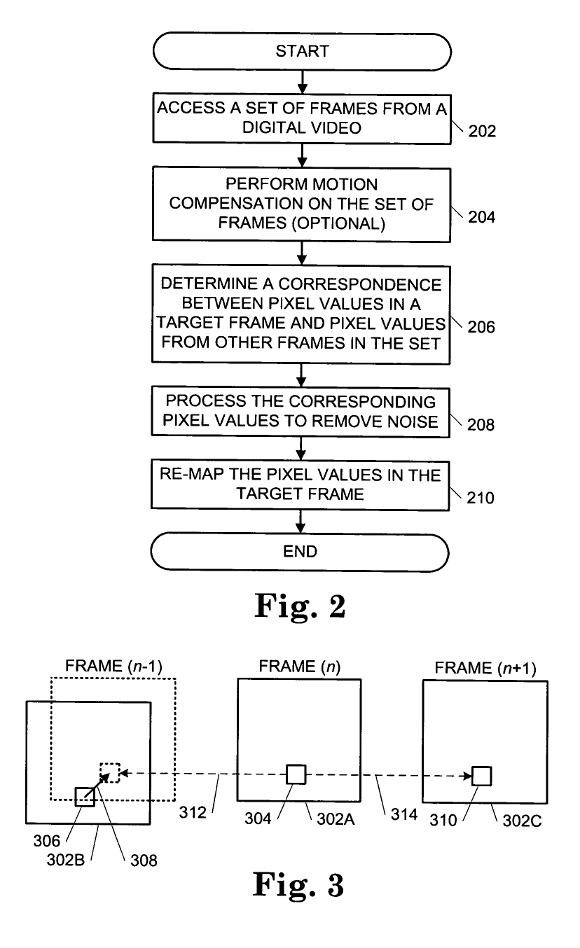

Referring back to FIG. 1, processing system 100 executes video enhancement module 110, motion compensation module 112 and noise removal module 114 to generate enhanced digital video 122 from digital video 120. In doing so, video enhancement module 110, motion compensation module 112, and noise removal module 114 remove noise from digital video 120 to generate enhanced digital video 122. The operation of video enhancement module 110, motion compensation module 112 and noise removal module 114 according to various embodiments will now be described with reference to FIGS. 2 through 8.

FIG. 2 is a flow chart illustrating a method for removing noise from a digital video 120. The method may be performed by processing system 100 using video enhancement module 110, motion compensation module 112 and noise removal module 114 for each frame of digital video 120.

In FIG. 2, processing system 100 executes video enhancement module 110 to access a set of frames from digital video 120 as indicated in a block 202. The set of frames may comprise any number of frames prior to a target frame and any number of frames subsequent to the target frame, e.g., three frames prior to the target frame and three frames subsequent to the target frame. FIG. 3 illustrates a set of frames that comprises a target frame (n) 302A, a previous frame (n−1) 302B, and a next frame (n+1) 302C where n is an integer that designates a frame 302 in a sequential series of frames 302 of digital video 120. In one embodiment, each frame 302 comprises separate red, green, and blue color frames. In other embodiments, each frame 302 may comprise other separate or intermixed color frames.

Processing system 100 optionally executes motion compensation module 112 to perform motion compensation on the set of frames as indicated in a block 204. More particularly, processing system 100 executes motion compensation module 112 to separately motion compensate previous frame 302B and/or next frame 302C as well as any frames 302 prior to previous frame 302B and/or subsequent to next frame 302C with respect to target frame 302A. In the example of FIG. 3, motion compensation module 112 adjusts previous frame 302B to effectively align pixel 306 in previous frame 302B with pixel 304 in target frame 302A as indicated by an arrow 308. The function of block 204 may be omitted with next frame 302C because pixel 310 is substantially aligned with pixel 304 in target frame 302A.

Processing system 100 executes noise removal module 114 to determine a correspondence between pixel values in a target frame and pixel values from other frames in the set as indicated in a block 206. The correspondences is shown in FIG. 3 where a correspondence is identified between pixel 304 of target frame 302A and motion compensated pixel 306 of frame 302B as indicated by a dashed arrow 312. Similarly, a correspondence is identified between pixel 304 of target frame 302A and pixel 310 of frame 302C as indicated by a dashed arrow 314. Other correspondences may be also calculated between pixels in frames subsequent to frame 302B and/or prior to frame 302C for other pixel values in target frame 302A (not shown).

Using the correspondence, processing system 100 executes noise removal module 114 to process the corresponding pixel values to remove noise as indicated in a block 208. More particularly, noise removal module 114 extracts information from the corresponding pixel values in the target frame and the other frames in the set and uses the information to generate processed values.

Processing system 100 executes noise removal module 114 to re-map the pixel values in the target frame using the processed values as indicated in a block 210. The processed values comprise a set of pixel values calculated from the pixel values in the target frame and pixel values from the other frames in the set. By re-mapping the pixel values in the target frame with the processed values, noise may be removed from the target frame.

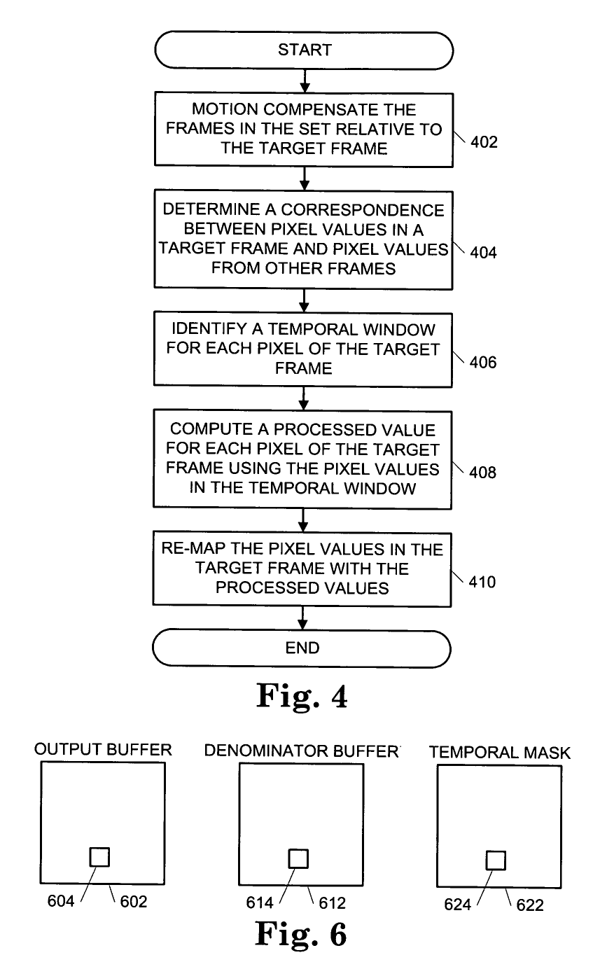

FIG. 4 is a flow chart illustrating a method for reducing noise digital video 120 using temporal windows. The method may be performed by processing system 100 using video enhancement module 110, motion compensation module 112 and noise removal module 114 for each frame of digital video 120.

In FIG. 4, processing system 100 executes motion compensation module 112 to perform motion compensation on the set of frames as indicated in a block 402. In the example of FIG. 3, processing system 100 executes motion compensation module 112 to separately motion compensate previous frame 302B and/or next frame 302C as well as any frames 302 prior to previous frame 302B and/or subsequent to next frame 302C with respect to target frame 302A. The function of block 402 may be omitted in some embodiments.

Processing system 100 executes noise removal module 114 to determine a correspondence between pixel values in a target frame and pixel values from other frames in the set as indicated in a block 404. Using the correspondence, processing system 100 executes noise removal module 114 to identify a temporal window for each pixel in the target frame as indicated in a block 406. The temporal window comprises corresponding pixel values from n frames prior to the target frame that are within a threshold of the pixel value of the target frame and corresponding pixel values from m frames subsequent to the target frame that are within a threshold of the pixel value of the target frame, where n and m are integers greater than or equal to zero. The size of the temporal window may vary for each pixel of the target frame. For example, the temporal window may be relatively large, i.e., cover a large number of frames in the set, in a portion of the target frame that is relatively unchanged compared to other frames in the set. In contrast, the temporal window may be relatively small, i.e., cover a small number of frames in the set (e.g., one or two frame), in a portion of the target frame that changes (e.g., by motion or a scene change) compared to other frames in the set.

Processing system 100 executes noise removal module 114 to compute a processed value for each pixel of the target frame using the pixel values in the temporal window for the pixel as indicated in a block 408. More particularly, noise removal module 114 computes a processed value as an average or a median of the pixel values in the temporal window for each pixel according to one embodiment. In other embodiments, noise removal module 114 computes the processed value in other ways.

Processing system 100 executes noise removal module 114 to re-map the pixel values in the target frame with the processed values as indicated in a block 410. Accordingly, each pixel value of the target frame may be replaced by a processed value that is generated from a temporal window for each pixel. By re-mapping the pixel values in the target frame with the processed values, noise may be removed from the target frame.

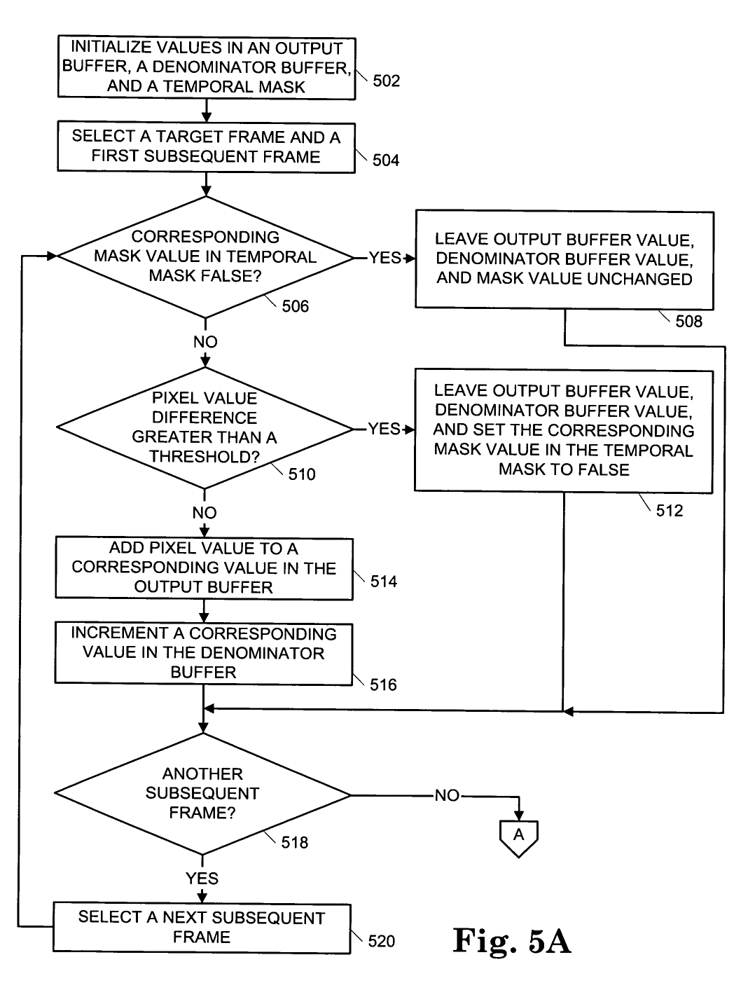

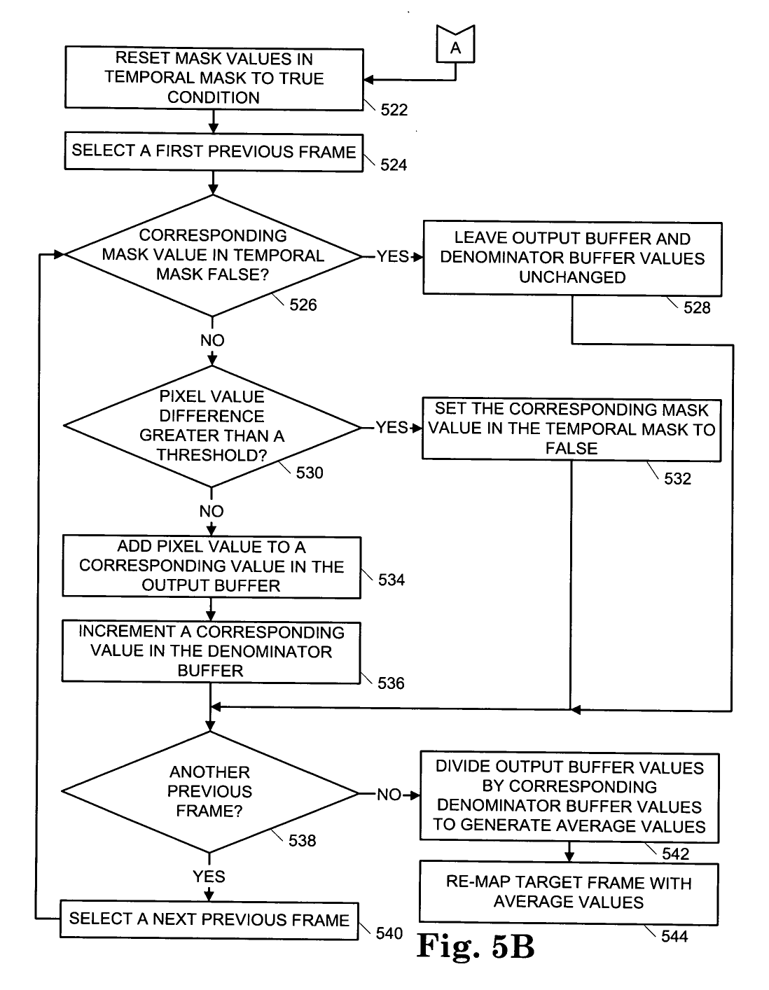

FIGS. 5A and 5B are a flow chart illustrating a method for calculating and re-mapping pixel values as described in blocks 406, 408, and 410 of FIG. 4. The method may be performed by processing system 100 using video enhancement module 110 and noise removal module 114 for each frame of digital video 120. FIG. 6 is a block diagram illustrating information used to calculate and re-map pixel values using the method of FIGS. 5A and 5B. FIG. 6 illustrates an output buffer 602 with an output buffer value 604, a denominator buffer 612 with a denominator buffer value 614, and a temporal mask 622 with a mask value 624. Output buffer 602, denominator buffer value 614, and temporal mask 622 each comprise a number of values equal to the number of pixel values in the target frame.

Referred to FIGS. 5A and 6, processing system 100 executes noise removal module 114 to initialize values in output buffer 602, denominator buffer value 614, and temporal mask 622 as indicated in a block 502. More particularly, noise removal module 114 initializes the values of output buffer 602 with the values of the target frame, initializes the values in denominator buffer 612 to one, and initializes the values in temporal mask 622 to values that represent a true condition, e.g., a value of one where a value of zero represents a false condition.

Processing system 100 executes noise removal module 114 to select a target frame and a first subsequent frame as indicated in a block 504. Processing system 100 executes noise removal module 114 to perform the series of functions of blocks 506 through 516 for each pixel in the target frame. For illustrative purposes, these functions will be described with reference to single pixel value in the target frame that corresponds to output buffer value 604, denominator buffer value 614, and mask value 624.

A determination is made by processing system 100 in executing noise removal module 114 as to whether mask value 624 that corresponds to the pixel value of the target frame indicates the false condition as indicated in a block 506. The false condition indicates that the subsequent frame is outside of the temporal window for the pixel of the target frame. If mask value 624 indicates the false condition, then processing system 100 executes noise removal module 114 to leave the values in output buffer value 604, denominator buffer value 614, and mask value 624 unchanged as indicated in a block 508.

If mask value 624 does not indicate the false condition, then a determination is made by processing system 100 in executing noise removal module 114 as to whether the difference between the pixel value in the target frame and the pixel value in the subsequent frame is greater than a threshold value as indicated in a block 510. A difference that is greater than the threshold indicates that the subsequent frame is outside of the temporal window for the pixel of the target frame. If the difference between the pixel value in the target frame and the pixel value in the selected frame is greater than a threshold value, then processing system 100 executes noise removal module 114 to leave output buffer value 604 and denominator buffer value 614 unchanged and set the corresponding mask value 624 to the false condition as indicated in a block 512.

If the difference between the pixel value in the target frame and the pixel value in the selected frame is not greater than a threshold value, then processing system 100 executes noise removal module 114 to add the pixel value of the selected frame to output buffer value 604 in output buffer 602 as indicated in a block 514. Processing system 100 further executes noise removal module 114 to increment denominator buffer value 614 in denominator buffer 612 that corresponds to the pixel value of the target frame as indicated in a block 516.

A determination is made by processing system 100 in executing noise removal module 114 as to whether there is another subsequent frame to process as indicated in a block 518. In one embodiment, noise removal module 114 processes a set number of frames subsequent to the target frame. Accordingly, noise removal module 114 determines that there is another subsequent frame to process in this embodiment until the set number of subsequent frames is reached. In another embodiment, noise removal module 114 determines that there is another subsequent frame to process until all or a minimum number of the mask values in temporal mask 622 indicate the false condition.

If there is another subsequent frame to process, then processing system 100 executes noise removal module 114 to select the next subsequent frame and repeat the function of block 506 as indicated in a block 520 and subsequent blocks using the next subsequent frame.

If there is not another subsequent frame to process, then the method continues at point A in FIG. 5B. In FIG. 5B, processing system 100 executes noise removal module 114 to reset the mask values, including mask value 624 in temporal mask 622 to the true condition as indicated in a block 522.

Processing system 100 executes noise removal module 114 to select a first previous frame as indicated in a block 524. Processing system 100 executes noise removal module 114 to perform the series of functions of blocks 526 through 536 for each pixel in the target frame. For illustrative purposes, these functions will be described with reference to single pixel value in the target frame that corresponds to output buffer value 604, denominator buffer value 614, and mask value 624.

A determination is made by processing system 100 in executing noise removal module 114 as to whether mask value 624 that corresponds to the pixel value of the target frame indicates the false condition as indicated in a block 526. The false condition indicates that the previous frame is outside of the temporal window for the pixel of the target frame. If mask value 624 indicates the false condition, then processing system 100 executes noise removal module 114 to leave the values in output buffer value 604, denominator buffer value 614, and mask value 624 unchanged as indicated in a block 528.

If mask value 624 does not indicate the false condition, then a determination is made by processing system 100 in executing noise removal module 114 as to whether the difference between the pixel value in the target frame and the pixel value in the previous frame is greater than a threshold value as indicated in a block 530. A difference that is greater than the threshold indicates that the previous frame is outside of the temporal window for the pixel of the target frame. If the difference between the pixel value in the target frame and the pixel value in the selected frame is greater than a threshold value, then processing system 100 executes noise removal module 114 to leave output buffer value 604 and denominator buffer value 614 unchanged and set the corresponding mask value 624 to the false condition as indicated in a block 532.

If the difference between the pixel value in the target frame and the pixel value in the selected frame is not greater than a threshold value, then processing system 100 executes noise removal module 114 to add the pixel value of the selected frame to output buffer value 604 in output buffer 602 as indicated in a block 534. Processing system 100 further executes noise removal module 114 to increment denominator buffer value 614 in denominator buffer 612 that corresponds to the pixel value of the target frame as indicated in a block 536.

A determination is made by processing system 100 in executing noise removal module 114 as to whether there is another previous frame to process as indicated in a block 538. In one embodiment, noise removal module 114 processes a set number of frames previous to the target frame. Accordingly, noise removal module 114 determines that there is another previous frame to process in this embodiment until the set number of previous frames is reached. In another embodiment, noise removal module 114 determines that there is another previous frame to process until all or a minimum number of the mask values in temporal mask 622 indicate the false condition.

If there is another previous frame to process, then processing system 100 executes noise removal module 114 to select the next previous frame as indicated in a block 540 and repeat the function of block 526 and previous blocks using the next previous frame.

If there is not another previous frame to process, then processing system 100 executes noise removal module 114 to divide the output buffer values by the denominator buffer values to generate average values as indicated in a block 542. Processing system 100 executes noise removal module 114 to re-map the pixel values in the target frame with the average values as indicated in a block 544.

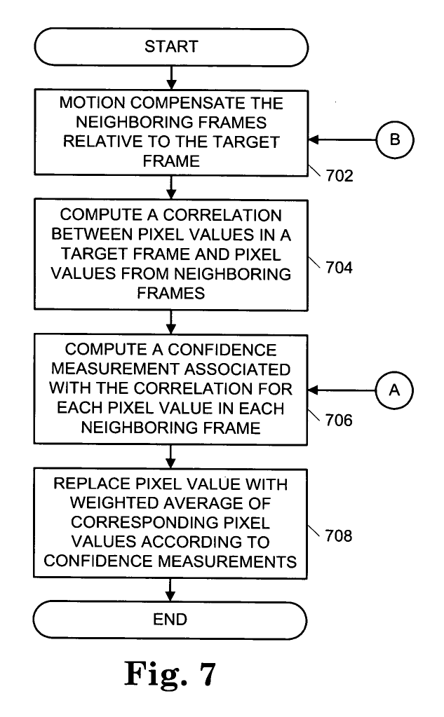

FIG. 7 is a flow chart illustrating a method for reducing noise digital video 120 using confidence measures. The method may be performed by processing system 100 using video enhancement module 110, motion compensation module 112 and noise removal module 114 for each frame of digital video 120.

In FIG. 7, processing system 100 executes motion compensation module 112 to perform motion compensation on the neighboring frames relative to the target frame as indicated in a block 702. Processing system 100 executes motion compensation module 112 to separately motion compensate each neighboring frame with respect to the target frame to generate a set of motion vectors associated with each neighboring frame. The motion vectors estimate the inter-frame motion of features or objects appearing in the target frame. In one embodiment, motion compensation module 112 generates the motion vectors using an affine motion model. In another embodiment, motion compensation module 112 represents the motion vectors as vector fields in the coordinate system of the target image to allow each frame in the set to be warped to the coordinate frame of the target frame. In other embodiments, motion compensation module 112 generates the motion vectors in other ways. Processing system 100 executes motion compensation module 112 to re-map each neighboring frame relative to the target frame using the respective motion vectors.

Processing system 100 executes noise removal module 114 to compute a correspondence between pixel values in a target frame and pixel values from other motion compensated neighboring frames as indicated in a block 704. Processing system 100 executes noise removal module 114 to compute a confidence measurement associated with the correspondence for each pixel value in each neighboring frame as indicated in a block 706. For each correspondence value computed in block 704, noise removal module 114 computes a confidence measurement that indicate levels of confidence of the correspondence.

In one embodiment, noise removal module 114 computes a set of confidence measurements for each re-mapped frame in the set where the confidence measurements are classified as either valid or invalid motion classes based on the correlations between the pixel values in the target frame and the pixel values in a re-mapped frame in the set. For correlations that are above a threshold, noise removal module 114 classifies the confidence measurements in the valid motion class. For correlations that are below a threshold, noise removal module 114 classifies the confidence measurements in the invalid motion class.

In the valid motion class, noise removal module 114 further classifies the confidence measurements as high motion, intermediate motion, or low motion based on the relative amount of motion between the target frame and the corresponding re-mapped frame in the set.

Processing system 100 executes noise removal module 114 to replace the pixel values in the target frame with a weighted average of corresponding pixel values from neighboring frames according to the confidence measurements as indicated in a block 708. The corresponding pixels with relatively high confidence measurements are weighted more highly than corresponding pixels with relatively low confidence measurements.

In one embodiment where the confidence measurements are classified as an invalid motion class or valid motion class with high motion, intermediate motion, or low motion as described above, noise removal module 114 computes the weighted average differently depending on the motion class.

For confidence measurements that indicate the invalid motion class, noise removal module 114 omits the pixel values in the neighboring frames associated with such confidence measurements in computing the weighted average

For confidence measurements that indicate a high motion class, noise removal module 114 computes the weighted average using weighted pixel values from up to two nearest neighbor frames on each side of the target frame. For confidence measurements that indicate an intermediate motion class, noise removal module 114 computes the weighted average using weighted pixel values from up to four nearest neighbor frames on each side of the target frame. For confidence measurements that indicate a low motion class, noise removal module 114 computes the weighted average using weighted pixel values from up to six nearest neighbor frames on each side of the target frame. Other numbers of pixel values from the nearest neighbor frames may be used for the high motion, intermediate motion, and low motion classes in other embodiments.

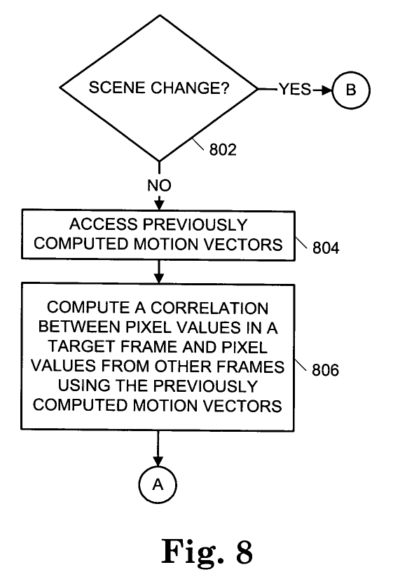

FIG. 8 is a flow chart illustrating a method for reducing noise digital video 120 previously computed motion vectors. The method may be performed by processing system 100 using video enhancement module 110, motion compensation module 112 and noise removal module 114 for each frame of digital video 120.

In FIG. 8, a determination is made by processing system 100 in executing video enhancement module 110 as to whether there is a scene change for the current target frame relative to a previously processed target frame as indicated in a block 802. In one embodiment, processing system 100 detects a scene change by comparing frames in digital video 120. In other embodiments, processing system 100 detects a scene change from information included with digital video 120. For example, if digital video 120 comprises an MPEG video format, processing system 100 detects a scene change from the MPEG header file of digital video 120.

If there is not a scene change, then processing system 100 executes noise removal module 114 to access previously computed motion vectors as indicated in a block 804. Processing system 100 executes noise removal module 114 to compute a correspondence between pixel values in a target frame and pixel values from other frames in the set using the previously computed motion vectors as indicated in a block 806. The method continues at block 706 of FIG. 7 as indicated by the label A.

If there is a scene change, then the method continues at block 702 of FIG. 7 as indicated by the label B.

Using the system and method described above, noise such as film grain in a digital video, including noise propagated from a video medium in generating the digital video, may be removed. Accordingly, the display of the digital video may be enhanced.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

What is claimed is:

1. A method performed by a processing system, the method comprising:
determining a correspondence between a first pixel value in a first frame of a digital video and a second pixel value in a second frame of the digital video;
processing the first pixel value and the second pixel value to remove noise and generate a third pixel value; and
re-mapping the first pixel value in the first frame with the third pixel value.

2. The method of claim 1 further comprising:
performing motion compensation on the second frame relative to the first frame prior to determining the correspondence.

3. The method of claim 1 further comprising:
determining a correspondence between the first pixel value in the first frame and a fourth pixel value in a third frame of the digital video; and
processing the first pixel value, the second pixel value, and the fourth pixel value to remove noise and generate the third pixel value.

4. The method of claim 3 wherein the second frame is prior to the first frame in the digital video, and wherein the third frame is subsequent to the first frame in the digital video.

5. The method of claim 1 further comprising:
identifying a temporal window that comprises the first pixel value and the second pixel value prior to processing the first pixel value and the second pixel value.

6. The method of claim 1 further comprising:
identifying a temporal window that comprises the first pixel value and the second pixel value in response to determining that the second pixel value is within a threshold prior to processing the first pixel value and the second pixel value.

7. The method of claim 1 further comprising:
adding the second pixel value to an output buffer value corresponding to a pixel associated with the first pixel value in an output buffer in response to determining that a difference between the second pixel value and the first pixel value is less than a threshold;
incrementing a denominator buffer value corresponding to the pixel associated with the first pixel value in a denominator buffer in response to determining that the difference is less than the threshold; and
dividing the output buffer value by the denominator buffer value to generate the third pixel value.

8. The method of claim 7 further comprising:
setting a mask value in a temporal mask to indicate a false condition in response to detecting that a difference between a fourth pixel value in a third frame of the digital video and the first pixel value is greater than the threshold.

9. The method of claim 1 further comprising:
processing the first pixel value and the second pixel value to remove noise and generate the third pixel value according to a confidence measurement associated with the correspondence.

10. The method of claim 9 wherein the third pixel value comprises a weighted average of the first pixel value and the second pixel value.

11. The method of claim 9 further comprising:
computing the confidence measurement associated with the correspondence.

12. The method of claim 1 further comprising:
re-mapping the second frame relative to the first frame using a set of motion vectors computed between the second frame and a third frame in response to not detecting a scene change associated with the first frame.

13. A system comprising:
a processor; and
a memory system for storing a digital video and a video enhancement module;
wherein the processor is configured to execute the video enhancement module to:
determine a correspondence between a first plurality of pixel values in a first frame of a digital video and a second plurality of pixel values in a second frame of the digital video;
process the first plurality of pixel values and the second plurality of pixel values to remove noise and generate a third plurality of pixel values; and
re-map the first plurality of pixel values in the first frame with the third plurality of pixel values.

14. The system of claim 13 wherein the processor is configured to execute the video enhancement module to:
perform motion compensation on the second frame relative to the first frame prior to determining the correspondence.

15. The system of claim 13 wherein the processor is configured to execute the video enhancement module to:
determine a correspondence between the first plurality of pixel values in the first frame and a fourth plurality of pixel values in a third frame of the digital video; and
process the first plurality of pixel values, the second plurality of pixel values, and the fourth plurality of pixel values to remove noise and generate the third plurality of pixel values.

16. The system of claim 13 wherein the processor is configured to execute the video enhancement module to:
identify a temporal window for each of the first plurality of pixel values by identifying the second plurality of pixel values that are within a threshold prior to processing the first plurality of pixel values and the second plurality of pixel values.

17. The system of claim 13 wherein the processor is configured to execute the video enhancement module to:
add each of the second plurality of pixel values whose difference between a corresponding one of the first plurality of pixel values is less than a threshold to a corresponding one of a plurality of output buffer values in an output buffer;
increment a corresponding one of a plurality of denominator buffer values in a denominator buffer for each of the second plurality of pixel values whose difference between a corresponding one of the first plurality of pixel values is less than the threshold; and
divide the plurality of output buffer values by the plurality of denominator buffer values to generate the third plurality of pixel values.

18. The system of claim 17 wherein the processor is configured to execute the video enhancement module to:
set a corresponding one of a plurality of mask values in a temporal mask to indicate a false condition for each of the second plurality of pixel values whose difference between a corresponding one of the first plurality of pixel values is greater than the threshold.

19. The system of claim 13 wherein the processor is configured to execute the video enhancement module to:
process the first pixel value and the second pixel value to remove noise and generate the third pixel value according to a confidence measurement associated with the correspondence.

20. The system of claim 19 wherein the third pixel value comprises a weighted average of the first pixel value and the second pixel value.

21. The system of claim 19 wherein the processor is configured to execute the video enhancement module to:
compute the confidence measurement associated with the correspondence.

22. The system of claim 13 wherein the processor is configured to execute the video enhancement module to:
re-map the second frame relative to the first frame using a set of motion vectors computed between the second frame and a third frame in response to not detecting a scene change associated with the first frame.

23. A system comprising:
means for determining a first correspondence between a first pixel value in a first frame of a digital video and a second pixel value in a second frame of the digital video;
means for determining a second correspondence between the first pixel value in the first frame and a third pixel value in a third frame of the digital video;
means for processing the first pixel value, the second pixel value, and the third pixel value to remove noise and generate a fourth pixel value; and
means for re-mapping the first pixel value in the first frame with the fourth pixel value.

24. The system of claim 23 further comprising:
means for performing motion compensation on the second frame relative to the first frame prior to determining the first correspondence; and
means for performing motion compensation on the third frame relative to the first frame prior to determining the second correspondence.

25. The system of claim 23 wherein the second frame is prior to the first frame in the digital video, and wherein the third frame is subsequent to the first frame in the digital video.

26. The system of claim 23 further comprising:
means for identifying a temporal window that comprises the first pixel value, the second pixel value, and the third pixel value prior to processing the first pixel value, the second pixel value, and the third pixel value.

27. The system of claim 23 further comprising:
means for identifying a temporal window that comprises the first pixel value, the second pixel value, and the third pixel value in response to determining that the second pixel value and the third pixel value are within a threshold prior to processing the first pixel value, the second pixel value, and the third pixel value.

28. The system of claim 23 further comprising:
means for adding the second pixel value to an output buffer value corresponding to the first pixel value in an output buffer in response to determining that a first difference between the second pixel value and the first pixel value is less than a threshold;
means for adding the third pixel value to the output buffer value corresponding to the first pixel value in the output buffer in response to determining that a second difference between the third pixel value and the first pixel value is less than the threshold;
means for incrementing a denominator buffer value corresponding to the first pixel value in a denominator buffer in response to determining that the first difference is less than the threshold; and
means for incrementing the denominator buffer value corresponding to the first pixel value in the denominator buffer in response to determining that the second difference is less than the threshold;
means for dividing the output buffer value by the denominator buffer value to generate the fourth pixel value.

29. The system of claim 28 further comprising:
means for setting a mask value corresponding to the first pixel in a temporal mask to indicate a false condition in response to detecting that a difference between a fourth pixel value in a fourth frame of the digital video and the first pixel value is greater than the threshold.

30. The system of claim 23 further comprising:
processing the first pixel value and the second pixel value to remove noise and generate the third pixel value according to a confidence measurement associated with the correspondence.

31. The system of claim 30 wherein the third pixel value comprises a weighted average of the first pixel value and the second pixel value.

32. The system of claim 30 further comprising:
computing the confidence measurement associated with the correspondence.

33. The system of claim 23 further comprising:
re-mapping the second frame relative to the first frame using a set of motion vectors computed between the second frame and a third frame in response to not detecting a scene change associated with the first frame.

34. A program product comprising a computer-readable medium including instructions executable by a processing system for:
determining a correspondence between a first pixel value in a first frame of a digital video and a second pixel value in a second frame of the digital video;
processing the first pixel value and the second pixel value to remove noise and generate a third pixel value; and
re-mapping the first pixel value in the first frame with the third pixel value.

35. The program product of claim 34 wherein the computer-readable medium includes instructions executable by the processing system for:
performing motion compensation on the second frame relative to the first frame prior to determining the correspondence.

36. The program product of claim 34 wherein the computer-readable medium includes instructions executable by the processing system for:
identifying a temporal window that comprises the first pixel value and the second pixel value prior to processing the first pixel value and the second pixel value.

37. The program product of claim 34 wherein the computer-readable medium includes instructions executable by the processing system for:
processing the first pixel value and the second pixel value to remove noise and generate the third pixel value according to a confidence measurement associated with the correspondence.

38. The program product of claim 34 wherein the computer-readable medium includes instructions executable by the processing system for:
re-mapping the second frame relative to the first frame using a set of motion vectors computed between the second frame and a third frame in response to not detecting a scene change associated with the first frame.
